(19) United States
(12) Patent Application Publication
(10) Pub. No.: US 2003/0127807 A1
(43) Pub. Date: Jul. 10, 2003

(54) High temperature seal

(76) Inventors: D. Gregory More, Middletown, CT (US); Amitava Datta, East Greenwich, RI (US)

Correspondence Address: WIGGIN & DANA LLP, ATTENTION: PATENT DOCKETING, ONE CENTURY TOWER, P.O. BOX 1832, NEW HAVEN, CT, 06508-1832, US

(21) Appl. No.: 10/278,867

(22) Filed: Oct. 24, 2002

Related U.S. Application Data
(60) Provisional application No. 60/341,102, filed on Oct. 29, 2001.

(51) Int. Cl. F16J 15/46

(52) U.S. Cl. 277/628

(57) ABSTRACT

A metallic seal offers improved resistance to high temperature stress relaxation. In certain embodiments, two seal layers mechanically interfit. In one embodiment, the two layers each include a cut-out, and the cut-outs are stagger such that the cut-out of a first layer covers the cut-out of a second layer. In another embodiment, a metallic seal includes one layer comprised of a hardened metallic alloy.

### CROSS-REFERENCE TO RELATED APPLICATION(S)

This patent application claims priority to U.S. Provisional Patent Application Serial No. 60/341,102 entitled “HIGH-TEMPERATURE SEAL” that was filed on Oct. 29, 2001, the disclosure of which is incorporated by reference in its entirety herein as if set forth at length.

### BACKGROUND OF THE INVENTION

(1) Field of the Invention

This invention relates to seals, and more particularly to metallic seals.

(2) Description of the Related Art

A variety of metallic seal configurations exist. Key metallic seals are commonly held under compression between two opposed flanges of the elements being sealed to each other. Such metallic seals may be used in a variety of industrial applications.

Key examples of such metallic seals are of an annular configuration, having a convoluted radial section which permits the seal to act as a spring and maintain engagement with the flanges despite changes or variations in the flange separation. Certain such seals have an S-like section while others have a section similar to the Greek letter ε with diverging base and top portions. Other similar seals are formed with additional convolutions. One exemplary seal is sold by The Advanced Products Company, North Haven, Conn., as the E-RING seal. Such seals are commonly formed as a monolithic piece of stainless steel or superalloy. Such seals are commonly formed from sheet stock into a shape which is effective to provide the seal with a desired range of compressibility from a relaxed condition. These seals are installed in applications in a compressed state as shown in FIG. 1. The total compression (Δh_{T}) consists of an elastic component (Δh_{EL}) and plastic component (Δh_{PL}) so that

Δh_{T}=Δh_{EL}+Δh_{PL}

With continued exposure at elevated temperatures, the plastic component Δh_{PL} grows resulting from creep and the elastic component Δh_{EL} decreases with time. As a result, the sealing load or the capability of the seal to follow the flange movement also diminishes with time resulting from the reduced Δh_{EL}. This phenomenon is called stress relaxation.

### BRIEF SUMMARY OF THE INVENTION

Long-term applications of current metallic seals are generally limited to about 1300° F. because the current cold formable nickel-based superalloys such as INCONEL 718 (Special Metals Corporation, Huntington, W. Va.) and WASPALOY (Haynes International, Inc., Kokomo, Ind.), lose their strength at temperatures greater than 1300° F. and stress relax. At temperatures beyond about 1350° F., static seals under compression stress relax and a fraction of the compression strain converts permanently to plastic strain with exposure time. As a result, the sealing force, which is proportional to the elastic strain, diminishes with time thereby increasing leakage. Additionally, the seal loses its capability to follow the mating flanges if they retract to a position of greater separation (lesser compression).

The phenomenon of stress relaxation under constant strain stems from creep at elevated temperatures where the gamma prime precipitates in 718 and WASPALOY begin to coarsen, thereby increasing the rate of plastic (irreversible) flow. Hence, the temperature capability of static metallic seals could be enhanced if the gamma prime precipitate distribution is more stable well above 1350° F. Alternatively, the metallic alloys could be strengthened via solid solution hardening without any gamma prime precipitates or dispersion hardening where the particle dispersion imparting strength is stable at or above the application temperature.

There are other cast metallic alloys, such as MAR M247 (a cast superalloy used in manufacture of turbine engine blades available from Cannon-Muskegon Corporation, Muskegon, Mich., as CM 247) which are used at ultra high temperatures (about 2000° F. or 1100° C.) for thick cross section cast and wrought components. These alloys can not readily be rolled into thinner gauges and cold formed into static seal shapes.

Recently developed mechanically alloyed strips such as MA 754 of Special Metals Corporation and PM 1000 of Plansee A G, Reutte, Austria, with superior high temperature strength characteristics are also very difficult to fabricate into seal shapes.

Some of the refractory alloy strips such as molybdenum base (e.g., titanium-zirconium-molybdenum (TZM)) and niobium base alloys, although cold formable, have poor oxidation resistance above 1200° F. (649° C.). Therefore, no current metallic alloy can readily be cold formed into seal and used at demanding elevated temperature applications requiring enhanced stress relaxation resistance.

### BRIEF DESCRIPTION OF THE DRAWINGS

FIG. 1 is a radial sectional view of a metallic seal as known to those in the art.

FIG. 2 is a radial sectional view of a first metallic seal according to principles of the present invention.

FIGS. 3A-C are radial sectional views of manufacturing stages of a second seal according to principles of the present invention.

FIGS. 4A-C are radial sectional views of manufacturing stages of a third seal according to principles of the present invention.

FIGS. 5A-C are radial sectional views of manufacturing stages of a fourth seal according to principles of the present invention.

FIG. 6 is a radial sectional view of a fifth metallic seal according to principles of the present invention.

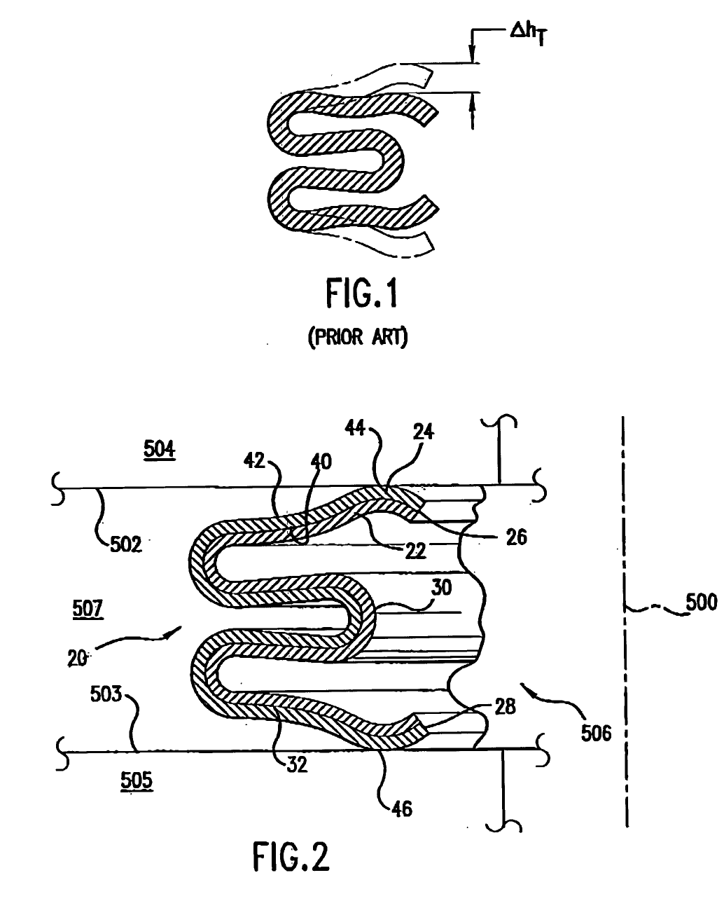

Like reference numbers and designations in the various drawings indicate like elements.

### DETAILED DESCRIPTION

Current metallic static seals are generally made of precipitation hardened nickel base superalloys such as Alloy 718 and WASPALOY whose long-term application temperatures are generally limited to 1200-1350° F. In accordance with the present invention, ultra high temperature (UHT) metallic seals with long-term application temperatures above 1350° F. can be designed and fabricated using any of the following metallic alloys:

a. Gamma prime or any other precipitation hardened metallic alloys where precipitation temperature is above the application temperature. Such an alloy is RENE 41 ((UNS-N07041) Allvac Incorporated, Monroe, N.C.), nominal composition percentages by weight 1.6 Al, 0.007 B, 0.05 C, 19.0 Co, 11.0 Cr, 3.0 Fe, 9.75 Mo, 3.15 Ti, remainder Ni plus impurities). Its precipitation hardening temperature is about 1600° F. Another example is Haynes new alloy HX (66% Ni, 17% Cr and balance Fe (by weight)) that could be precipitation hardened by forming very stable nitrides when heated in a nitrogen atmosphere for long-term applications above 1350° F.

b. A solid solution hardened alloy such as Haynes 25 ((UNS No. R30605) nominal composition percentages by weight 20Cr, 15W, 0.10Ni, 1.5Mn, 0.10C, 3Fe max., 0.4Si max., 51 (balance) Co plus impurities), Haynes 188 ((UNS No. R30188) nominal composition percentages by weight 22Ni, 22Cr, 14W, 0.35Si, 0.10C, 0.03La, 3Fe max., 1.25Mn max, 39 (balance) Co plus impurities), or Haynes 230 ((UNS No. N06230) nominal composition percentages by weight 22Cr, 14W, 2Mo, 0.5Mn, 0.4Si, 0.3Al, 0.10C, 0.02La, 5Co max., 3Fe max., 0.015B, 57 (balance) Ni plus impurities) that do not contain any precipitates whose distribution becomes unstable above 1350° F.

c. A dispersion hardened alloy, which is hardened by very stable oxide particles dispersion whose distribution is stable well above 1350°. Such metallic alloys, called Oxide Dispersion Strengthened alloys (ODS), are PM 1000 (Nominal chemical composition in weight %: 20 Cr, 3 Fe, 0.5 Ti, 0.3 Al, 0.6 Y₂O₃, remainder Ni), PM2000 (Nominal chemical composition in weigth %: 20 Cr, 5.5 Al, 0.5 Ti, 0.3 Al, 0.5 Y₂O₃, remainder Fe), PM 3000, MA 754 ((UNS N07754) Nominal Chemical Composition, wt. % 78Ni, 20Cr, 1.0Fe, 0.05C, 0.3Al, 0.5Ti, 0.6Yttrium Oxide) and MA 956((UNS S67956) Nominal Chemical Composition, wt. % 74Ni, 20Cr, 4.5Al, 0.5Ti, 0.05C, 0.5 Y₂O₃).

d. Seals are also fabricated using multiple-ply (layer) design to combine the application characteristics of either a, b and c above. A specific application could be a combination of a solid solution hardened alloy such as Haynes 25 and RENE 41. This combination provides an enhanced resistance to stress relaxation over a greater temperature range; RENE 41 providing strength below 1600° F. and Haynes 25 above 1600° F.

Also, by using Haynes 25 on an outer ply, the need for an antigalling coating could be eliminated as the cobalt-base Haynes 25 demonstrates a superior antigalling and wear characteristics. “Base” means more than 50%, by weight, of the recited element.

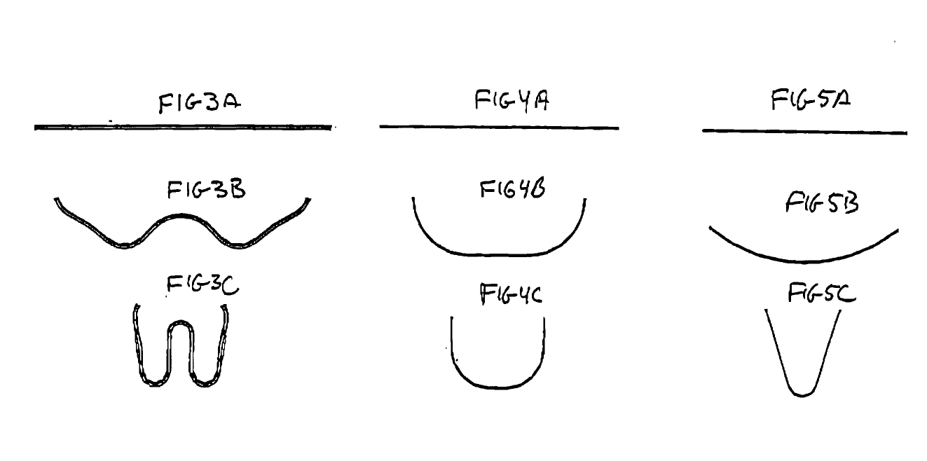

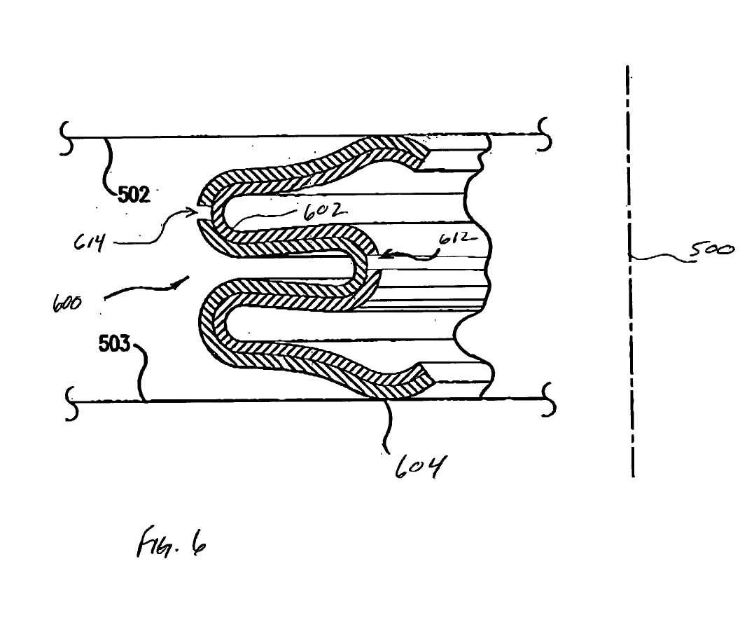

All the above alloys are easily cold formable and the strips can be joined by welding or brazing to form bands prior to roll-forming into a suitable cross-section as E, U or V (as illustrated, for example, in FIGS. 3C, 4C and 5C) generally employed for static metallic seals.

Therefore, the ease of cold formability and joining in addition to enhanced stress relaxation characteristics superior to WASPALOY above 1350° F. are the necessary criteria for UHT seals metallic alloys.

In one embodiment, a seal manufacturing process includes:

1. Cut material for bands to exact length and width.

2. Weld bands to form hoops and inspect each weld.

3. Assemble multiple plys (if appropriate).

4. Form desired seal section (U, V or E) with associated tooling.

5. Inspect each seal dimensionally.

6. Clean and heat treat seals.

7. Plate or coat if required.

8. Hand polish or lap if required.

9. Inspect each seal visually and dimensionally.

10. Test seals, if required.

11. Seals packed and shipped.

FIG. 2 shows a seal 20 formed as an annulus having symmetry about a central longitudinal axis 500. In operation, the seal is held in compression between opposed parallel facing surfaces 502 and 503 of first and second flanges 504 and 505 to isolate an interior volume 506 from an exterior volume 507.

The seal is formed as a convoluted sleeve having first and second layers 22 and 24 and extending from a first end 26 to a second end 28. In the exemplary embodiment, the first layer 22 is generally interior of the second layer 24 and has first and second surfaces 30 and 32, respectively. Similarly, the second layer 24 has first and second surfaces 40 and 42, respectively. In an exemplary manufacturing process, the layers 22 and 24 are initially formed as flat strips of cold formable material (i.e., it may be formed into a complex shape (e.g., having a radial section of bellows-like structure) at a temperature which is less than half its melting temperature and, preferably, at ambient conditions (e.g., room temperature)). The ends of each strip may be welded to form a sleeve, the two faces of the strip thereby becoming interior and exterior faces of the sleeve. The sleeves may be assembled concentrically and deformed into a convoluted shape such as that shown in FIG. 2.

In one embodiment the result of this process is the production of a seal (e.g., seal 20) in which the layers (e.g., layers 22 and 24) are held together by macroscopic mechanical interfitting rather than adhesion at the microscopic level between the inner surface 40 of the layer 24 and the outer surface 32 of the layer 22. There may be a gap between the layers 22 and 24 or multiple gaps between the layers 22 and 24 (where the layers contact at one or more discrete annular regions). It may be possible that there is discrete microscopic bonding (e.g., spot welds or annular welds at particular locations), and may also be no microscopic bonding at all. A major portion of the outer surface 42 of the layer 24 constitutes the external surface of the seal in contact with the volume 507. Portions 44 and 46 of the surface 42 slightly recess from the ends 26 and 28, face longitudinally outward and provide bearing surfaces for contacting the flange surfaces 502 and 503 to seal therewith. Each of the layers 22 and 24 preferably makes a substantial contribution to the longitudinal compression strength and performance of the seal 20. Preferably in an anticipated range of operation, each layer 22 and 24 contributes at least ten percent (10%) and, preferably, thirty percent (30%). As noted above, the contribution provided by each layer depends upon factors including, for example, the operating temperature.

Exemplary thermal operating conditions for the seal are in the range of about 1600-2000° F. (about 871-1093° C.) or even more. A more narrow target is about 1700-1900° F. (about 927-1038° C.). It should be appreciated that this does not necessarily mean that the seal can not be used under more conventional conditions.

FIGS. 3A-3C, 4A-4C and 5A-5C depict manufacturing stages of single ply (layer) seal designs, in accordance with the present invention, which employ the aforementioned metallic alloys (described in a., b. and c. above, for example, RENE 41, Haynes 25, PM1000 and other ODS alloys).

Referring again to FIG. 2, the inventors have formed seals exhibiting features of the present invention (as described herein) as convoluted sleeves having: a first layer (e.g., layer 22) comprised of an ODS alloy (e.g., PM1000, PM2000, MAR M247) and a second layer (e.g., layer 24) comprised of a wear resistant alloy (Haynes 25 or Ultimet (54% Co, 26% Cr)); a first layer comprised of a solution hardenable alloy (e.g., Inconel 718, Waspaloy) and a second layer comprised of a wear resistant alloy (e.g., Haynes 25 or Ultimet (54% Co, 26% Cr)); a first layer comprised of a solid solution alloy (e.g., Haynes 25) and a second layer comprised of a wear resistant alloy (e.g., Haynes 25 or Ultimet (54% Co, 26% Cr)); and a first layer comprised of an ODS alloy (e.g., PM1000, PM2000, MAR M247) and a second layer of ODS alloy (e.g., PM1000, PM2000, MAR M247).

In another embodiment of the present invention a seal is cut or split so as not to form a continuous ring. For example, a seal having an outer diameter of about 32 inches may include a “cut-out” having an arc length of about 0.100 inch such that the seal is no longer a continuous ring. Such a cut can facilitate, for example, installing the seal into certain cavities. That is, a seal having the aforementioned cut-out can be “snaked” into a cavity that is not otherwise accessible with a solid formed ring.

As can be appreciated, split seals have a gap (e.g., cut-out) that leads to excess leakage for in the gap area there is no sealing as there is no sealing element. FIG. 6 depicts a two ply seal 600 having first and second layers 602 and 604 that each include cut-outs, shown generally at 612 and 614, along the layers. In one embodiment, the layers 602 and 604 are split such that the cut-outs 612 and 614 are stagger by, for example, about one (1) inch. As such, the first layer 602 covers the cut-out 614 of the second layer 604 and the second layer 604 covers the cutout 612 of the first layer 602.

One or more embodiments of the present invention have been described. Nevertheless, it will be understood that various modifications may be made without departing from the spirit and scope of the invention. For example, the relaxation resistant material layer may be located in discrete locations along the length of the seal rather than continuously along the length. Such refractory material may be localized to portion of the seal where the greatest flexing occurs. Accordingly, other embodiments are within the scope of the following claims.

What is claimed is:

1. An annular seal having a central longitudinal axis and forming a seal between interior and exterior volumes when held under compression between opposed first and second faces of respective first and second flanges, comprising:
a metallic first layer; and
a metallic second layer;
wherein the first layer is a solid solution hardened alloy and the second layer consists essentially of an age hardening nickel-base superalloy.

2. The seal of claim 1 wherein the first layer is substantially an outer layer.

3. The seal of claim 2 wherein the first layer consists essentially of a cobalt-nickel-chromium-tungsten alloy and the second layer comprises 10-25% chromium and 7-14% cobalt.

4. The seal of claim 1 having a radial section of bellows-like structure.

5. The seal of claim 1 wherein only the first layer of the seal is in contact with the exterior volume.

6. The seal of claim 1 wherein the first and second layers are not mechanically bonded to each other but are held together only by mechanical interfitting at the macroscopic level.

7. The seal of claim 1 wherein there are one or more gaps between the first and second layers.

8. The seal of claim 1 wherein the first and the second layers each include a cut-out, and wherein the cut-outs are stagger such that the cut-out of the first layer covers the cut-out of the second layer and the cut-out of the second layer covers the cut-out of the first layer.

9. A method of manufacturing a seal, comprising:
cutting a first piece of a first material to a first length and first width;
cutting a second piece of a second material to a second length and width;
forming the first and second materials into first and second hoops;
welding ends of each piece of material to each other;
concentrically assembling the first and second hoops; and
deforming the assembled hoops to create a convoluted cross-section.

10. The method of claim 9 wherein the convoluted cross-section is comprised of one of a E, U and V cross-section formed with associated tooling.

11. An annular seal having a central longitudinal axis and forming a seal between interior and exterior volumes when held under compression between opposed first and second faces of respective first and second flanges, the seal comprising a solid solution hardened metallic alloy.

12. The seal of claim 11 wherein the hardened metallic alloy is selected from one of RENE 41, Haynes 25, PM1000 and other ODS alloys.
